(19) United States
(12) Patent Application Publication
(10) Pub. No.: US 2020/0126434 A1
(43) Pub. Date: Apr. 23, 2020

(54) Method Of Performing Work Related To Delivery

(71) Applicant: Ilya Vladimirovich Redkokashin, Rostov-on-Don (RU)

(72) Inventor: Ilya Vladimirovich Redkokashin, Rostov-on-Don (RU)

(21) Appl. No.: 16/474,091

(22) PCT Filed: Dec. 28, 2017
(86) PCT No.: PCT/RU2017/000997

§ 371 Date: Jun. 27, 2019

(30) Foreign Application Priority Data
Dec. 29, 2016 (RU) 20169152513

(51) Int. Cl. G08G 5/00; G06Q 50/28; B64C 39/02

(52) U.S. Cl. CPC G08G 5/0069; B64C 2201/128; B64C 39/024; G06Q 50/28

(57) ABSTRACT

FIELD: transportation.

SUBSTANCE: invention relates to logistics, in particular to ways to deliver goods using unmanned aerial vehicles. Method includes fixing a unique identifier and a delivery area outside the facade of the apartment building in the form of a mechanism installed outside the facade of the apartment building. Delivery area receives information about the identifier of the addressee and the cargo from the unmanned aerial vehicle, then moves the cargo inside the apartment building and leaves the above-mentioned cargo near the identifier belonging to the addressee located inside the apartment building.

EFFECT: provides the expansion of the functionality of unmanned aircraft during delivery, as well as the identification of addresses of apartments in the apartment building from the side of the building.

### TECHNICAL FIELD

The invention relates to the field of trade, in particular to the delivery. More specifically, the invention relates to the methods of delivery, using unmanned aerial vehicles and preparing for such a delivery.

### PRECEDING LEVEL OF TECHNOLOGY

At present, there is a known method of delivering parcels by “Russian Post”, in which a postman carries parcels to different addressees. The known method is convenient due to the logistics of mailings, as well as a large number of offices located near blocks of flats. But the aforementioned method is not economical, as a lot of money goes to postmen's wages.

The known methods of delivery using unmanned aerial vehicles, are also described by Amazon. The methods generally describe delivery using unmanned aerial vehicles, where first they identify the user ID, then determine the place in the yard to which the package or goods will be delivered, and after receiving the order from the user or package, they send the unmanned aerial vehicle using the navigation system. This method is economical for a company as there is no need to pay postmen or couriers, but the method has its drawback. The described method is not suitable for the use in a large city with blocks of flats as most city residents do not have their own land plot, but they have only a mailbox that is located inside the block of flats, where the unmanned aerial vehicle cannot reach, also existing mailboxes are not suitable for interaction with an unmanned aerial vehicle, and consequently, the implementation of delivery to the resident of a block of flats in the described way becomes impossible.

Thus, the above and other similar solutions do not solve all of these problems simultaneously.

The task that the developer of a way of doing work related to the delivery has set for himself, is to develop a method that would identify the addresses of apartments in the block of flats from the front of the building and use unmanned aerial vehicles on delivery to residents of blocks of flats.

The technical result of the method of performing work related to the delivery is to expand the functionality of unmanned aerial vehicles on delivery, save money, when delivering to residents of blocks of flats, save time when delivering to residents of blocks of flats, identify addresses of apartments in a block of flats from the front of the building.

### DISCLOSURE OF INVENTION

Method of performing work connected with delivery, in which a unique identifier is attached to the front of the house outside of a block of flats for further use in the delivery of unmanned aerial vehicles. Near the unique identifier there may be a delivery area, made in the form of a mechanism, or a static structure or an element. The identifier, as well as the delivery area, can be assigned to each apartment or office on the front of a block of flats, taking into account their location. The delivery area can be made in the form of a mechanism that receives information about the addressee's identifier and the cargo of the unmanned aerial vehicle, further moves the cargo inside the block of flats and leaves the above-mentioned cargo near the identifier belonging to the addressee located inside the block of flats. The delivery area can also be made in the form of a door or a hole that allows an unmanned aerial vehicle to penetrate the interior of a block of flats and leave a load near the addressee's identifier located inside the block of flats. The identifier can be made in the form of a sensor or a visual image. The identifier can also be fixed virtually by storing it in the database.

The delivery area is done in the form of a metal fastener on which a cargo can be placed, or for which a package with a cargo can be hooked, or as a mechanism allowing to take automatically the cargo of an unmanned aerial vehicle and transfer the above-mentioned cargo to the apartment to which the above-mentioned mechanism belongs. After fixing the identifier and the delivery area for each apartment outside on the front of a block of flats using unmanned aerial vehicles and navigation systems, the cargo is delivered, during which the unmanned aerial vehicle reaches the block of flats, identifies the apartment from the outside and, determining the delivery area, comes into contact with it leaving the cargo. After fixing only the identifier outside on the front of the block of flats, using unmanned aerial vehicles and navigation systems, the cargo is delivered, during which the unmanned aerial vehicle reaches the block of flats, externally identifies the block of flats or individual apartment and, having notified the addressee, waits until the addressee takes the cargo. Quadrocopters are used as unmanned aerial vehicles. The addressee receives a notice of delivery of the cargo after it. During delivery, the addressee is made an opportunity to monitor cargo movements.

### EXAMPLE OF A SPECIFIC APPLICATION OF THE INVENTION

The inventive method of performing work associated with the delivery is as follows. To implement the method in the built-in memory of unmanned aerial vehicles, or in a database that can be located either in the built-in memory or remotely on the server, they store information relating to the identifier being created. This information may be entered later, for example, just before delivery itself Further, on the front of a block of flats, on a selected apartment or office, a unique identifier is fixed, allowing unmanned aerial vehicles to recognize the apartment or office of the addressee from the outside, which is intended to deliver some cargo, for example, a letter, order from an online store, etc. The identifier can be made, for example, in the form of a plate with the apartment number, which the unmanned aerial vehicle can visually recognize with the help of a video camera. The identifier can also be made in the form of a sensor, the signals of which are capable of catching devices installed on unmanned aerial vehicles, or being part of them, and the above-mentioned devices can request a signal from a sensor that is in a wait mode. The identifier can be fixed virtually. For these purposes, for example, as the above-mentioned information relating to the identifier being created, an image of a block of flats and its coordinates in the navigation system are stored in the database and, with the help of augmented reality, they virtually impose identifiers on the image of a block of flats. The identifier may be located taking into account the location of the selected apartment in a block of flats. Further, when the identifier is fixed, the delivery area is fixed near the identifier. The delivery area is the end point where the cargo arrives after delivery with unmanned aerial vehicles. The delivery area is made in the form of a mechanism, a static structure or an element, and in such a way that the unmanned aerial vehicle (hereinafter referred to as UAV) can come into contact with it and leave the cargo. For example, the delivery area can be made in the form of a hook, for which the UAV can catch a cargo, for example, packed in a bag with handles. The delivery area can also be made, for example, in the form of a wide shelf on which the UAV can leave a cargo. In the form of a mechanism, the delivery area can be, for example, a retractable shelf, when the UAV approaches, advances to the street, and after consigning supplies, the cargo moves in automatically inside the apartment to which the delivery area belongs. The identifier and the delivery area are based on the location of the selected apartment in the block of flats, namely on the front of the block of flats opposite the selected apartment, for example, under one of the windows of the selected apartment.

The method also provides for the absence of a delivery area. In this case, the UAV, after arriving at the identifier, notifies the addressee of its arrival and waits while the addressee takes the cargo. The identifier may also be the only one for the whole block of flats, the addressee must go where all UAVs deliver the cargo to all residents of a single house to receive it. If there is one identifier on the front of a block of flats, the delivery area on the front can also be the only one in the whole block of flats and is designed as a mechanism, when receiving the cargo and information about addressees from the UAV, moves the cargo inside the block of flats and inside the aforementioned house, distribute the cargo according to identifiers located already inside the block of flats and belonging to different addressees.

The delivery area with a single identifier on the front of a block of flats can also be made in the form of a door, a hole, or a mechanism that allows the UAV to enter the block of flats when the cargo is delivered and leave the cargo near the addressee's identifier located inside the block of flats.

After fixing the identifier and, if it is necessary, the delivery area on the front of a block of flats using any of the proposed methods, the preparatory work for the delivery with the help of the UAV ends, and in the future the UAVs make delivery repeatedly as needed.

In the process of delivery the UAV, using the navigation system, reaches the target block of flats. Further, using an identifier located on the front of a block of flats, it determines which delivery area it is necessary to contact with. The identifier can be recognized by comparing information in the database and information received from the identifier. For example, if the identifier is a plate with symbols, the image received using the camera installed on the UAV is compared with the picture put in the database, and if the symbols match, the recipient is recognized. If the identifier is designed as a sensor, the signal from the identifier is compared with the signal stored in the database, etc. After recognizing the identifier, the UAV comes into contact with the delivery area. For example, it hooks a parcel or the goods in a package with handles if the delivery area is in the form of a hook. If the delivery area is made as a shelf, the UAV leaves the goods or a parcel on this shelf If the delivery area is made in the form of a door, the UAV flies inside the block of flats and leaves cargo near the identifier of the address located in the block of flats, etc. In the process of delivery, it is also possible to track goods that are in transit, for example, through a mobile application.

Fixing identifiers, and if it is necessary, the delivery area, and other devices which are necessary for the delivery of unmanned aerial vehicles, can be handled by individual companies, both connected and not to the companies making the delivery themselves with the help of unmanned aerial vehicles.

1. Method of performing work connected with delivery, in which a unique identifier and delivery area are fixed on the front of the block of flats, made in the form of a mechanism that receives information about the addressee's identifier and the cargo from the unmanned aerial vehicle outside the front of the block of flats, then it moves cargo inside the block of flats and leaves the above-mentioned cargo near the identifier belonging to the addressee located inside the block of flats for the further use in the delivery of unmanned aerial vehicles.

2. Method of performing work connected with delivery, based on claim 1, characterized by the identifier is made in the form of a sensor, or a visual image.

3. Method of performing work connected with delivery, based on claim 1, characterized by the identifier is fixed virtually by storing in the database.

4. Method of performing work connected with delivery, based on claim 1, characterized by that after fixing the identifier and the delivery area on the front of a block of flats using unmanned aerial vehicles and navigation system, the cargo is delivered, during which the unmanned aerial vehicle reaches the block of flats, it identifies the house outside and, determining the delivery area, comes into contact with it, leaving the goods and passing information about the addressee's identifier.

5. Method of performing work connected with delivery, based on claim 1, characterized by quadrocopters are used as unmanned aerial vehicles.

6. Method of performing work connected with delivery, based on claim 1, characterized by the addressee receives a notification of the delivery of the cargo after it.

7. Method of performing work connected with delivery, based on claim 1, characterized by the addressee is made the opportunity to monitor the movement of cargo during the delivery.
